(19) United States
(12) Patent Application Publication
(10) Pub. No.: US 2010/0321686 A1
(43) Pub. Date: Dec. 23, 2010

(54) DEVICE FOR OPTICAL SPECTROSCOPY AND MECHANICAL SWITCH FOR SUCH A DEVICE

(75) Inventors: Nico Correns, Weimar (DE); Felix Kerstan, Jena (DE); Doris Jochmann, Jena (DE); Werner Hoyme, Gebstedt (DE); Hans-Juergen Dobschal, Kleinromstedt (DE); Marcel Seeber, Jena (DE); Lutz Freytag, Jena (DE)

Correspondence Address: FISH & RICHARDSON P.C. (BO), P.O. BOX 1022, MINNEAPOLIS, MN, 55440-1022, US

(73) Assignee: CARL ZEISS MICROIMAGING GMBH, Jena (DE)

(21) Appl. No.: 12/795,235

(22) Filed: Jun. 7, 2010

(30) Foreign Application Priority Data
Jun. 23, 2009 (DE) 102009030468.1

(51) Int. Cl. G01J 3/04; G01J 3/02

(52) U.S. Cl. 356/310; 356/326

(57) ABSTRACT

The disclosure provides a device for optical spectrometry, wherein the reference beam and the measuring beam between the deflector and the detector input, in particular between the deflector output and the detector or between a device connecting the optical paths and the detector exhibit the same (the identical) etendue and the same (the identical) optical axis.

### CROSS-REFERENCE TO RELATED APPLICATION

This application claims priority under 35 U.S.C. §119 to German Patent Application DE 10 2009 030 468.1, filed Jun. 2, 2009. The contents of this applications is hereby incorporated by reference in its entirety.

### FIELD

The disclosure pertains to optical devices for optical spectrometry, with a reference surface, a light source for illuminating a sample position and for illuminating the reference surface, a spectrally resolving detector (spectrometer), an optical deflector upstream from the input of the detector, a measuring beam from the sample position to a first input of the deflector and a reference beam from the reference surface to a second input of the deflector, wherein the deflector can be switched between a first position for the coupling of the measuring beam onto the detector input and a second position for the coupling of the reference beam onto the detector input, and mechanical switches for the setting of one of at least two defined switching positions of a movable part exhibiting a motor and a stop for the movable part for the definition of the first switching position, with a first permanent magnet being attached to the movable part. The spectrally resolving detector may be designed as a single-channel or simultaneous multi-channel scanner.

### BACKGROUND

Optical spectometry is used to characterize the spectral reflecting power or transmission capability of measuring objects across a certain wavelength range of interest, in which one or multiple reflectivity and/or transmission intensity spectrums are captured in the form of a so-called radiation function. The radiation function can be used to obtain information about optical as well as non-optical properties of the measuring objects, which can then be used to evaluate the measuring objects in question. In this process, the emission characteristics of the light sources are not constant, due to aging or fluctuations in the supply voltage or the ambient temperature, for example. The spectral response curve of the detectors being used also varies with the ambient temperature and operating time, and so do the analog electronic detection circuits. A spectrometry device therefore can desirably be calibrated in order to obtain reproducible readings. This could also be used to compare the radiation functions of the same measuring object having been measured with two different light sources, for example. The calibration can be performed, for example, using one or multiple reference measuring objects (standards), which may be placed manually or automatically into the path of the measuring beam or alternately with a measuring object onto the sample position. For calibration, the measuring beam is used as the reference beam.

DE 195 28 855 A1 describes a device allowing repeated referencing between the measurements with little effort. For this purpose, a separate reference beam is used and the measuring beam is merged with the separate reference beam via a fiberoptic Y-cable, wherein inside of every branch of the cable is a switchable shutter. The fiberoptic Y-cable with the switchable shutters can be called an “optical deflector”, wherein the cross-section of the joint optical path between the deflector and the spectrometer is divided into the reference beam and the measuring beam. This joint optical path is coupled into the entry opening of the spectrometer. Due to the separate reference beam, the device can be quickly referenced since no reference measuring object desirably is placed into the sample position (internal serial referencing). However, due to the joint feed into the spectrometer by way of a fiberoptic Y-cable, the etendues (collecting powers) of the measuring beam and the reference beam are low since the entry opening of the spectrometer can be utilized only proportionately. A low etendue often involves long integration times, which may lead to an accumulation of errors. Due to the proportionate utilization of the entry opening, the reference light and the measuring light are also distributed inhomogeneously inside the entry opening, which further reduces the accuracy of detection.

An alternative to serial referencing or as an additional measure for the correction of short-term fluctuations of device properties is simultaneous referencing by way of a second spectrometer, as known from DE 100 10 213 A1, for example. In this case, any differences between the measuring and the reference spectrometers desirably is compensated by reference measurements. Although in this case, the etendue is high, there can be the particular drawback of the larger number of desired spectrometers.

A general problem of spectrometric measurements can also be that the radiation functions measured in the form of reflection and/or transmission depend on the optical transmission properties of the detection channels, which vary across the measured wavelengths: For example, the transmission characteristics of optical fibers may change due to mechanical or thermal influences (signal drift), in particular between the time of the reference measurement and time of the actual measurement. Especially problematic can be transmission differences between the measuring beam and the reference beam if they are designed to be separate. These problems exist independently of the reference measurement being performed in serial fashion or simultaneously. The accuracy of the measurements may be affected in any case.

When moving a mechanic component into one or more defined display positions there is the problem of bouncing back from a respective stop. There are various approaches to the debouncing of mechanical switches. Known from DE 25 32 563 A1, for example, is a device where a permanent magnet is attached to a pivoting part of a component, on which by way of two solenoids a switching force is applied to rotate the component between two stops. Here, the solenoids themselves serve as stops. With proper control, the bouncing of the rotating component can be reduced or completely eliminated. However, this device can exhibit the disadvantage that two solenoids are desired, and that a complex control sequence is involved to change the switching position.

### SUMMARY

The disclosure provides a device of the type described above, which can optionally involve a small number of spectrometers while at the same time allowing referencing and measuring with high accuracy, and to provide a switch of the type described above, allowing low-effort toggling with reduced bouncing into at least one switching position. The disclosure provides a device for optical spectrometry, wherein the reference beam and the measuring beam between the deflector and the detector input, in particular between the deflector output and the detector or between a device connecting the optical paths and the detector exhibit the same (the identical) etendue and the same (the identical) optical axis. This means that they are running longitudinally along the same optical path. For this purpose, the inputs and the output of the deflector may have appropriate coupling optics, for example lenses or optionally imaging mirrors. The etendue of an optical path is defined by the product of the solid angle and cross-sectional surface of the path. If the joint optical path is formed by several optical fibers, the identity of the etendue and the optical axis of every single fiber is desired.

The disclosure is based on the realization that when an optical coupling path to the detector is used, which is identical for the reference and the measuring, the entry opening can be used evenly and nearly to the full extent, so that a maximum etendue is achieved at maximum homogeneity of the transmitted light. This permits short integration times. Furthermore, differences in the transmission of the reference beam and of the measuring beam affecting the accuracy of the measurements are reduced. Especially thermal or mechanical changes affect both optical paths when the optical paths are identical. The disclosure involves only one spectrometer (per spectral range).

The earlier the reference beam and the measuring beam are coupled onto the joint optical path, the greater these advantages will be. The deflector can therefore be positioned directly after the input optics of the measuring beam or only reflectors are positioned between the input optics and the deflector, in particular the inputs of the deflector. The same applies to the reference beam.

Devices in which the measuring beam, in particular also the reference beam, is free of optical fibers can be used. This minimizes thermal and mechanical influences on the measuring accuracy. The device is thermally and mechanically more resilient. There are only small signal drifts in the reference beam and the measuring beam. The device exhibits a continuously high etendue warranting highly accurate readings.

The deflector can be free of optical fibers because when coupled by optical Y-fibers, the fibers for the reference beam and the measuring beam run parallel to the detector, thereby not having the same optical path and exhibiting different optical axes resulting in the described disadvantages of the current the state of the art.

The entire device, including the reference surface (internal referencing) is purposefully enclosed inside a housing against environmental influences; the light from the light source and/or the light from the sample position is able to exit/enter the housing only via one or two windows.

For the compensation of dark currents and sensitivity variations, the reference surface can be referenced as internal white standard on one hand, and as a dark state on the other hand. The internal referencing of the dark state is especially easy if the deflector can be switched into a third position, in which it couples neither the reference beam nor the measuring beam into the detector input. In this position, the detector measures only its dark signals.

In some embodiments, the deflector exhibits a mechanical switch for the setting of the three deflector positions, wherein the switch has a recess, a light-tight first blade and a light-tight and light-absorbing second blade, wherein the recess and the blades can be alternatively moved into the measuring beam by operating the switch. The recess may also be called a gap between the two blades. For this reason, only a single switch is involved to couple the beams into one jointly usable optical path to the detector. The first blade can be mirrored on one side (or equipped with a mirrored part), so that in the positioned state the blade reflects one of the beams to the detector input while blocking the other beam, and the recess lets in the positioned state pass one beam into a light-trap and the other beam to the detector, while the second blade blocks both beams in the positioned state. This allows the switch to have simple design. For example, the blades are configured in a plane such that when the measuring beam and the reference beam are coming in at a right angle to each other, the positioned blade divides the right angle symmetrically. The blades and the recess can be located on the same pivoted part, thus involving only a single drive.

In certain embodiments, the first light input of the deflector has a first switchable optical shutter and the second light input has second switchable optical shutter, and the deflector comprises a beam splitter with a reflectance of less than 100%. This allows the coupling into the jointly used optical path with available, low-cost components. Due to a non-symmetrical divider ratio, the intensity reaching the detector can easily be specified, like based on the type and thickness of an optical coating, for example. In this case, the shutters are part of the deflector and also the inputs of the deflector.

In embodiments of the device, in which the light source, the reference surface, the sample position, the reference beam and the measuring beam are configured such that light from the sample position to the first light input and light from the reference surface to the second light input is conducted simultaneously.

This allows these components to be stationary and drives are not required. Measurement and internal referencing can be selected via the deflector only.

For this purpose, the reference surface and the input optics of the reference beam each are shaded against the light coming from the sample position, in particular by tilting the reference surface toward the light from the sample position and/or by placing the measuring surface and/or the input optics into a recess. This has the advantage that light scattered back from the sample cannot interfere with the reference beam, thus preventing any falsification of the reference and achieving highly accurate readings.

In some embodiments of the device, in which the measuring beam, optionally also the reference beam, as well as the deflector are free of optical fibers, the optical path between the deflector and the detector may advantageously be designed free of optical fibers and the detector may, in addition to spectrally resolving also spatially resolution for at least one dimension. Due to the fiber-free design, the spectrometer can be used to measure multiple points at the sample position along the spatially resolved dimension.

The disclosure provides a mechanical switch, wherein away from the movable part a second permanent magnet is attached such that in the respective switching position opposite magnetic poles of the first permanent magnet and the second permanent magnet are facing each other without touching each other, and which move away from each other every time, the movable part is deflected from the respective switching position. The disclosure comprises in particular a switchable, optical shutter with at least one blade for the blocking of an optical beam, which is either attached to the movable part of such switch or designed together with the switch in one piece.

The configuration of two permanent magnets located at a distance from each other and attracting each other significantly reduces bouncing due to the steep edges of the magnetic potential caused by the high reset forces during deflection. In strong magnets like magnets made of neodymium, for example, the potential at the center is on top of that very low, so that the switching position can be defined with high accuracy.

When the movable part is exclusively pivoted, only a single (bi-directional) drive is involved.

In another switching position, away from the movable part a third permanent magnet may advantageously be attached such that in the respective switching position opposite magnetic poles of the first permanent magnet and of the third permanent magnet are facing each other without touching each other, and which move away from each other every time, the movable part is deflected from the respective switching position. This allows the highly accurate definition of a second switching position. Additional switching positions can be defined accordingly. A step counter and/or one or multiple position sensors can be used to differentiate the individual switching positions. Alternatively, a purely pivoted component with two switching positions could be continuously switched into the same direction, thus toggling between the two switching positions without the need for additional devices.

The disclosure also includes an operating procedure for an inventive device, namely for reference measurements using the reference surface as white standard and the blocked reference beams and measuring beams as a dark state on one hand, as well as for measurements utilizing such referencing, in particular with serial in-between reference measurements, on the other hand.

### BRIEF DESCRIPTION OF THE DRAWINGS

In the following, the disclosure will be explained based on exemplary embodiments and drawings, in which:

FIGS. 1A and 1B are schematic representations of a device for optical spectrometry with an optical deflector, including a mirrored beam splitter,

FIG. 2 is a schematic representation of an alternative beam splitter,

FIG. 3 is a schematic view of an optical fiber-free device with a two-dimensional detector,

FIG. 4 is a schematic view of another device for optical spectrometry,

FIGS. 5A and 5B are schematic views of an optical deflector with a single switch with three switching positions, and

FIGS. 6A-6C are schematic views of different embodiments of such switches.

Identical parts are in all drawings indicated by the same numbers.

### DETAILED DESCRIPTION

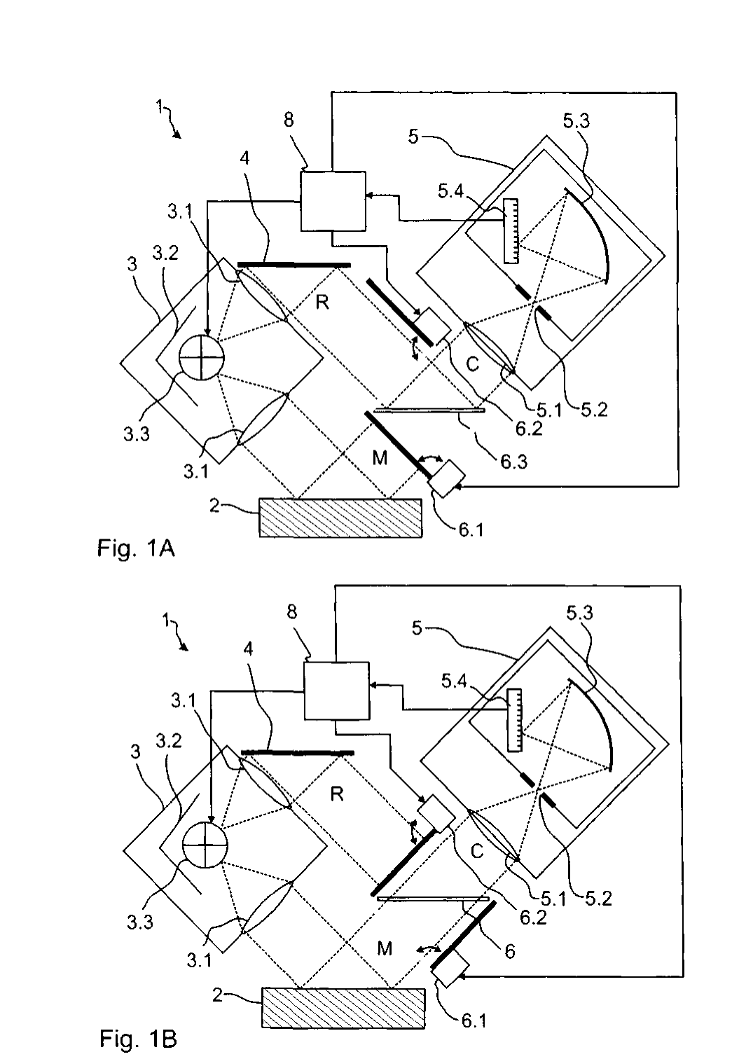

FIGS. 1A and 1B show schematic views of a system 1 configured for the spectrometric evaluation of a sample 2 with a lighting unit 3, a reference measuring object with a reference surface 4, a spectrometer as detector 5, an optical deflector 6 comprising two switchable optical shutters 6.1, 6.2 as inputs of the deflector 6, and a mirrored beam splitter 6.3 and a controller 8.

The lighting unit 3 includes, for example, a halogen lamp 3.3, a reflector 3.2 and optics 3.1 for the collimated lighting of the reference surface 4 and the sample 2 at the sample position. The detector 5 includes input optics 5.1, an entry gap as entry opening 5.2, an imaging grid 5.3, and a two-dimensionally spatially resolving opto-electronic sensor 5.4. From the reference surface 4, a reference beam R passes to the second shutter 6.2, continues focused through the beam splitter 6.3 and the input optics 5.1 to entry opening 5.2, from where incident light from the grid 5.3—under spatial-spectral resolution along a first dimension of sensor 5.4—is mapped onto the sensor 5.4 (here suggested for a single wavelength). A measuring beam M runs accordingly from the sample position (of sample 2) to the first shutter 6.1, continues via the beam splitter 6.3, and on the same optical path as the reference beam R through the input optics 5.1 to entry opening 5.2.

The beam splitter 6.3 is configured at an angle of 45° to the R and M beams, so that it principally connects the R and M beams as a connecting element, and where the reference beam R and the measuring beam M use the same optical path between the deflector 6 and the detector input 5.2. The splitter 6.3 has an asymmetric splitting ratio of 8:92, for example (reference beam to measuring beam). The shutters 6.1, 6.2 can be closed via the control unit 8 alternately or simultaneously, so that only one of the M/R beams reaches the detector 5.

The intensity values are measured as a function of the blocking and unblocking of the M/R transmission paths (beams) as follows, wherein in this embodiment the intensities are spectrally measured and wavelength-dependent:

| Intensity | Transmission Path R | Transmission Path M |
|---|---|---|
| I_{W} | Unblocked | Blocked |
| I_{Wi} | Blocked | Unblocked |
| I_{D} | Blocked | Blocked |
| I_{S} | Unblocked | Blocked |
| 1_{P} | Unblocked | Blocked |

with:

I_{W} being the intensity of the light reflected by the external white standard 11,

I_{Wi} being the intensity of the light reflected by the internal white reference surface 4,

I_{D} being the intensity when the detector surface is not illuminated,

I_{S} being the intensity of the light reflected by the external black standard 12, and

I_{P} being the intensity of the light reflected by the sample 2.

The following applies to the reflected intensities:

I_{W}=I·(R_{F}+R_{W}·[1−R_{F}]²)+I_{D}

I_{S}=I·(R_{F}+R_{S}·[1−R_{F}]²)+I_{D}

I_{P}=I·(R_{F}+R_{P}·[1−R_{F}]²)+I_{D}

I_{Wi}=Iᵢ·R_{Wi}+I_{D}

with

I: Intensity of radiation component A to the external sample position,

I_{w}: Intensity of radiation component B to the internal reference surface 10,

R_{w}: Reflectance of the external white standard 11,

R_{wi}: Reflectance of the internal white reference surface 4,

Rₛ: Reflectance of the external black standard 12,

R_{P}: Reflectance of sample 2,

R_{F}: Reflectance of the measuring head window 9.

The lighting unit 3, for example, permanently illuminates the reference surface 4 and simultaneously the sample 2. The optical paths M and R permanently capture light from sample 2 (the sample position) and, respectively, from the reference surface 4, guiding it to the deflector 6. For (initial or repeated) internal white referencing, the first shutter 6.1 at the first deflector input is closed and the second shutter 6.2 at the second input is opened (FIG. 1A). For (initial or repeated) internal black referencing both shutters are closed. The control unit 8 captures in both cases the signals (intensity values) of the sensor 5.4 and references the device based on these signals. The control unit may also include detector signals originating from an external white standard and an external black standard, which will have to be captured separately like a regular measurement. For the regular measurement the first shutter 6.1 is open and the second shutter 6.2 is closed (FIG. 1B).

Regarding the measuring sequence and to determine the reflectance we refer to DE 10 2007 061 213, whose disclosure content shall be included here in its entirety.

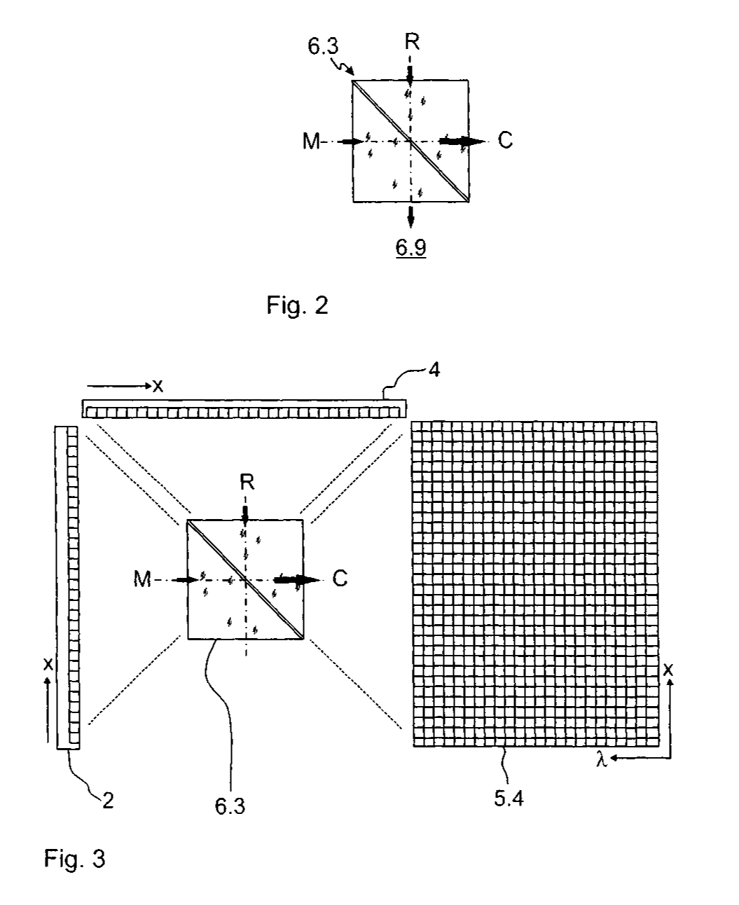

FIG. 2 shows a schematic view of an alternative embodiment for a beam splitter 6.2, which can be used in devices 1 according to FIGS. 1A, 1B and FIG. 3. This is a double-prism where the beam is split at the internal boundary surface.

FIG. 3 shows the two-dimensional sensor 5.4 and a respective series of positions of sample 2, which can be measured simultaneously or during the referencing to reference surface 4. For reasons of clarity, the shutters at the deflector inputs are not shown. Along the first dimension λ of the sensor 5.4 the incident light is spectrum-sliced by the grid 5.3. In traverse direction thereto a specific spectrum for every measuring point is mapped along the second dimension X onto the sensor 5.4. The matrix of sensor signals will be read by the control unit 8 (here not shown). Either one single measuring point X, multiple or all measuring points can actually be evaluated, as needed.

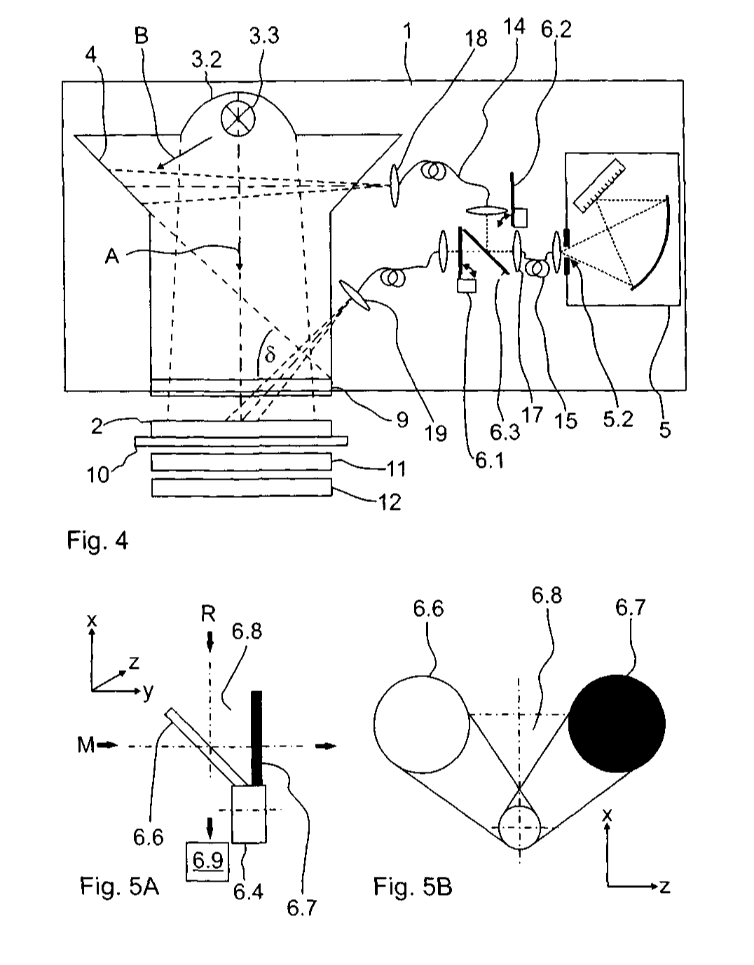

FIG. 4 shows a closed spectrometer measuring head as device 1. The measuring head 1, which is enclosed by a housing 30, includes an integrated reflector lamp 3.3 from which a first radiation component A is directed through a round measuring head window 9, for example, onto a sample holder 10, which defines a sample position. The sample holder 10 is provided and designed as receptacle for an external white standard 11, an external black standard 12, and a sample 2, for which the reflectance R_{P} shall be determined. The white standard 11, the black standard 12, and the sample 2 can be positioned on the sample holder 10, and are exchangeable with each other in a specified sequence. Inside the measuring head 1, a second radiation component B of the light emitted by the reflector lamp 3.3 is simultaneously directed onto a diffusely reflecting internal reference surface 4 designed as measuring scale of another white standard.

Furthermore provided inside the measuring head 1 are fiberoptic cables 14, 15, and 16. Provided upstream from fiberoptic cable 14 is a coupling optic 18 which is positioned to capture the scattered reflection from the internal white surface 4 and to couple it into fiberoptic cable 14. The light that is coupled into fiberoptic cable 14 via coupling optic 18 reaches the light entry side of a shutter 6.2 at the second input of an optical deflector 6 with a mirrored beam splitter 6.3, whose light-exiting side is connected to fiberoptic cable 15 via coupling optic 17. Fiberoptic cable 15 is connected to a first entry gap 5.2 of a spectrometer 5.

Provided upstream from fiberoptic cable 16 is a coupling optic 19 for the capture of light being reflected from the sample position—there either from the white standard 6, the black standard 7 or the surface of the sample 8 located on the sample holder 5—and which enters the measuring head 1 through the measuring head window 9. The light coupled into fiberoptic cable 16 by coupling optic 19 is forwarded inside fiberoptic cable 16 to the light entry side of a first shutter 6.1 at the first input of the deflector 6 and enters through the open first shutter 6.1 from the light-exiting side of the deflector 6 via coupling optic 17 into fiber optic cable 15. The optical path of the measuring beam M between the beam splitter 6.3 and the detector input 5.2 is therefore the same as for the reference beam R.

From FIG. 4 can furthermore be obtained that the internal reference surface 4 encloses an angle δ with the potential measuring surface at the sample position so that the internal reference surface 4 is tilted toward the propagation direction of the light reflected by the sample position into device 1 and bounces back from the wall 20 of the lighting channel preventing this light from impinging onto the internal reference surface 4 while still allowing simultaneous lighting by the lamp 3.3 and a simultaneous collection of light in beams M and R. Provided behind the measuring head window 9 may be multiple coupling optics optionally radial-symmetrically to (circular around) the irradiation direction of the light onto the sample position. Provided downstream from the coupling optics is one respective fiberoptic cable each, for example, in which the light reflected by the sample position through the measuring head window 9 into the measuring head 1 and collected by the coupling optics is forwarded to the deflector 6, from where it reaches sensor 5.4 via the joint fiberoptic cable 15 and entry gap 5.2 via the imaging grid 5.3.

Referencing, calibration and measurement take place as described with regard to FIGS. 1A and 1B.

FIGS. 5A and 5B show an optical deflector 6 with a mechanical switch 6.4 with a movable part 6.5, which is pivoted only. Disposed at the component 6.5 is a first blade 6.6, a second blade 6.7 and a recess 6.8 which, depending on the switching position, are positioned in the path of the beam of deflector 6. For this purpose, the movable part is equipped with an electric motor (not shown). The blades are configured at an angle of 45° to the M and R beams, which enter perpendicularly to each other. The first blade has on the side facing the reference beam R a mirrored surface, so that the light from the reference beam R is reflected to the detector 5 but light from the measuring beam M is blocked (absorbed or diffusely scattered into the overall unit), when this surface is located inside the path of the beam. Alternatively, the second side of the first blade can also be mirrored in order to guide the light from the measuring beam M into the light trap 6.9. The second blade is impermeable to light on both sides and blocks light from the reference beam R as well as the light from the measuring beam M when located inside the path of the beam of deflector 6. When the switch is positioned such that instead of one of the blades the recess 6 is located in the optical path of the deflector 6, both beams M, R will freely pass the deflector, allowing the light from the measuring beam M to reach the detector 5 and light from the reference beam R to reach the light trap 6.9.

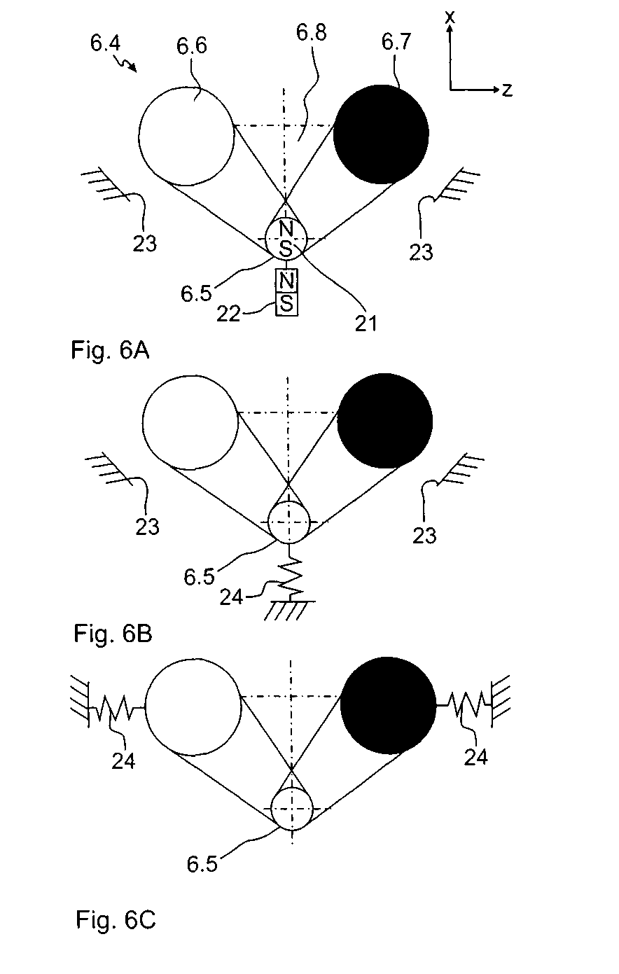

FIGS. 6A-6C outline possible embodiments of a mechanical switch 6.4 for utilization in a device 1. Attached to the movable part 6.5 are in all—just like in FIGS. 5A and 5B—two blades 6.6, 6.7 and a recess 6.8. In FIG. 6A, a first permanent magnet 21 is attached to the movable part in addition to the electric motor. The switching position associated with the recess 6.8 is magnetically defined by a second permanent magnet 22. The switching positions associated with the blades 6.6, 6.7 on the other hand are mechanically defined by respective stops 23. The north and south poles of the two magnets are facing each other in the respective switching position at a sample distance of 0.5 mm. When the movable part 6.5 is deflected by the electric motor from the switching position associated with the recess 6.8, the component 6.5 is affected by a high reset force which the motor desirably overcomes. Once the magnetic potential has been overcome, there isn't nearly any switching force involved in order to set and maintain one of the two other switching positions. In these switching positions, bouncing is clearly lower than in the state of the art as well. Conversely, the high reset force prevents significant overshooting and bouncing of the component 6.5 when the switching position associated with the recess 3.8 is activated. This switching position is also maintained when the motor is de-energized. Alternatively or in addition to the recess switching position, one or both switching positions of the blades may also be defined by permanent magnets.

In FIG. 6B, the magnet configuration is replaced by a conventional spring 24 engaging at the movable part 6.5. This variation has the disadvantage that the reset force increases as the deflection increases. The spring defines the center switching position but notably less clearly than in FIG. 6A since the harmonic potential is flatter. The outer switching positions involve a motoric switching and holding force.

FIG. 6C shows another alternative, in which the central switching position is defined by two conventional springs engaging at one blade 6.6 and 6.7 each. This alternative acts the same as the one shown in FIG. 6B but without a stop.

The following table provides an overview over possible variations of joint optical path, connecting component in the deflector, selection of the M/R beams, light energy reaching the detector on the selected sample, as well as the type of reference and measuring beam (Position “Off” stands for the blocking of both M/R beams as internal dark state):

| Var. | Joint Optical Path | Connector | Light is selected via | Energy to Detector | Light Path |
|---|---|---|---|---|---|
| 1 | Fiber | Splitter | Shutter 6.1 | 92% | Fiber |
| | | | Shutter 6.2 | 8% | Fiber |
| 2 | Fiber | Splitter | Shutter 6.1 | 92% | Fiber |
| | | | Shutter 6.2 | 8% | Open-beam |
| 3 | Fiber | Splitter | Shutter 6.1 | 92% | Open-beam |
| | | | Shutter 6.2 | 8% | Fiber |
| 4 | Fiber | Splitter | Shutter 6.1 | 92% | Open-beam |
| | | | Shutter 6.2 | 8% | Open-beam |
| 5 | Open-beam Optics | Splitter | Shutter 6.1 | 92% | Fiber |
| | | | Shutter 6.2 | 8% | Fiber |
| 6 | Open-beam Optics | Splitter | Shutter 6.1 | 92% | Fiber |
| | | | Shutter 6.2 | 8% | Open-beam |
| 7 | Open-beam Optics | Splitter | Shutter 6.1 | 92% | Open-beam |
| | | | Shutter 6.2 | 8% | Fiber |
| 8 | Open-beam Optics | Splitter | Shutter 6.1 | 92% | Open-beam |
| | | | Shutter 6.2 | 8% | Open-beam |
| 9 | Fiber | Switch 6.4 | M Position | 100% | Fiber |
| | | | R Position | 95% | Fiber |
| | | | Off Position | 0% | None |
| 10 | Open-beam Optics | Switch 6.4 | M Position | 100% | Open-beam |
| | | | R Position | 95% | Open-beam |
| | | | Off Position | 0% | None |

### REFERENCE LIST

1 Device for spectrometric analysis
2 Sample
3 Lighting unit
3.1 Optics
3.2 Reflector
3.3 Lamp
4 Reference surface
5 Detector
5.1 Input optics
5.2 Entry opening
5.3 Imaging grid
5.4 Optoelectronic sensor
6 Optical deflector
6.1 First shutter
6.2 Second shutter
6.3 Beam splitter
6.4 Mechanical switch
6.5 Movable part
6.6 First blade
6.7 Second blade
6.8 Recess
6.9 Light trap
7
8 Control unit
9 Measuring head window
10 Sample holder
11 External white standard
12 External black standard
13
14 Fiberoptic cable for reference light
15 Fiberoptic cable with identical optical path
16 Fiberoptic cable for measuring light
17 Coupling optics for the joint optical path
18 Coupling optics for reference beam
19 Coupling optics for measuring beam
20 Wall of the lighting channel
21 First permanent magnet
22 Second permanent magnet
23 Stop
24 Spring
M Measuring beam
R Reference beam
C Joint optical path
A First radiation component
B Second radiation component

What is claimed is:

1. A system, comprising:
a light source configured to emit light to illuminate a sample surface and a reference surface;
an optical deflector; and
a spectrally resolving detector,
wherein:
the optical deflector is switchable between first and second positions;
in the first position, the optical deflector is configured to couple the measuring beam to a first input of the spectrally resolving detector along a measuring beam from the sample surface to the spectrally resolving detector;
in the second position, the optical deflector is configured to couple the reference beam to a second input of the spectrally resolving detector along a reference beam from the reference surface to the spectrally resolving detector;
between the optical deflector and the spectrally resolving detector, the reference beam and the measuring beam have the same etendue and the same optical axis.

2. The system according to claim 1, wherein the optical deflector is free of optical fibers.

3. The system according to claim 1, wherein the optical deflector is located directly after an input optic of the measuring beam, or wherein only one or more reflectors are located between the input optic and the optical deflector.

4. The system according to claim 1, wherein the optical deflector is switchable into a third position, in which the optical deflector is configured to couple neither the reference beam nor the measuring beam to the spectrally resolving detector.

5. The system according to claim 4, wherein:
the optical deflector comprises a mechanical switch configured to set the position of the optical defector among the first, second and third positions;
the mechanical switch comprises a recess, a first blade that is light-tight, and a second blade that is light-tight and light-absorbing;
the recess, the first blade and the second blade can alternately be moved into the path of the measuring beam.

6. The system according to claim 5, wherein:
the first blade is mirrored on one side so that, when the first blade is in the path of the measuring beam, the first blade reflects a first beam to the spectrally resolving detector and blocks a second beam from reaching the spectrally resolving detector;
when located in the path of the measuring beam, the recess allows either the first beam or the second beam to pass to a light trap and allows the other of the first and second beams to pass to the spectrally resolving detector;
when located in the path of the measuring beam, the second blade blocks both the first and second beams from reaching the spectrally resolving detector;
the first beam is the measuring beam; and
the second beam is the reference beam.

7. The system according to claim 4, further comprising a first switchable optical shutter at a first light input of the optical deflector; and a second switchable optical shutter at a second light input of the optical deflector, a second switchable optical shutter, wherein the optical deflector comprises a beam splitter having a reflectance of less than 100%.

8. The system according to claim 7, wherein the beam splitter has an asymmetrical divider ratio.

9. The system according to claim 1, wherein the system is configured to simultaneously illuminate the first and second inputs of the spectrally resolving detector with light emitted by the light source.

10. The system according to claim 9, wherein the reference surface and one input optic of the reference beam are shaded from light coming from the sample position.

11. The system according to claim 1, wherein the measuring beam is free of optical fibers.

12. The system according to claim 11, wherein the optical path between the optical deflector and the spectrally resolving detector is free of optical fibers, and the spectrally resolving optical detector is spatially resolving in at least one dimension.

13. A system, comprising:
a light source configured to emit light to illuminate a sample surface and a reference surface;
an optical deflector;
a mechanical switch; and
a spectrally resolving detector,
wherein:
the mechanical switch is configured to switch the optical deflector between first and second positions;
in the first position, the optical deflector is configured to couple the measuring beam to a first input of the spectrally resolving detector along a measuring beam from the sample surface to the spectrally resolving detector;
in the second position, the optical deflector is configured to couple the reference beam to a second input of the spectrally resolving detector along a reference beam from the reference surface to the spectrally resolving detector;
between the optical deflector and the spectrally resolving detector, the reference beam and the measuring beam have the same etendue and the same optical axis.

14. The system according to claim 13, wherein the mechanical switch comprises a recess, a first blade that is light-tight, and a second blade that is light-tight and light-absorbing.

15. The system according to claim 14, wherein the recess, the first blade and the second blade can alternately be moved into the path of the measuring beam.

16. The system according to claim 15, wherein:
the first blade is mirrored on one side so that, when the first blade is in the path of the measuring beam, the first blade reflects a first beam to the spectrally resolving detector and blocks a second beam from reaching the spectrally resolving detector;
when located in the path of the measuring beam, the recess allows either the first beam or the second beam to pass to a light trap and allows the other of the first and second beams to pass to the spectrally resolving detector;
when located in the path of the measuring beam, the second blade blocks both the first and second beams from reaching the spectrally resolving detector;
the first beam is the measuring beam; and
the second beam is the reference beam.

17. A mechanical switch configured to switch a setting of a moveable part between first and second positions, the mechanical switch comprising:
a drive; and
a first permanent magnet attached to the moveable part; and
a second permanent magnet disposed away from the moveable part,
wherein, in a given switching position, opposite magnetic poles of the first and second permanent magnets face each other without touching each other, and move away from each other with every deflection of the moveable part from the given switching position.

18. The mechanical switch according to claim 17, wherein the moveable part is pivotable only.

19. The mechanical switch according to claim 17, further comprising a third permanent magnet disposed away from the moveable part, wherein, in the given position, opposite magnetic poles of the first and third permanent magnets face each other without touching each other, and move away from each other with every deflection of the moveable part from the given switching position.

20. The mechanical switch according to claim 17, wherein an optical shutter is attached to the moveable part or integral with the moveable part, the optical shutter comprising at least one blade configured to block an optical beam.
